(19) United States
(12) Patent Application Publication
(10) Pub. No.: US 2013/0111403 A1
(43) Pub. Date: May 2, 2013

(54) IN-VEHICLE DISPLAY APPARATUS

(71) Applicant: Yuuko NAKAMURA, Kariya-city (JP)

(72) Inventor: Yuuko NAKAMURA, Kariya-city (JP)

(73) Assignee: DENSO CORPORATION, Kariya-city (JP)

(21) Appl. No.: 13/616,013

(22) Filed: Sep. 14, 2012

(30) Foreign Application Priority Data
Oct. 28, 2011 (JP) 2011-237156

(51) Int. Cl. G06F 3/048; G06F 3/041

(52) U.S. Cl. 715/810

(57) ABSTRACT

An in-vehicle display apparatus includes a finger position detector, which detects an approach of a finger and a finger approach position, a display controller, which controls a display panel to display operation icons, and a touch panel switch, which is disposed on a surface of the display panel and transmits, to the display controller, an input signal corresponding to an operation icon manipulated by a user. In a case where the operation icons are displayed in a rearrange target display mode in which the operation icons are to be rearranged and a display control start condition is satisfied, the display controller controls the display panel to display the operation icons in an adjacence display mode in which the operation icons are arranged adjacent to the finger approach position, when the approach of the finger is detected. Further, the display controller executes a predetermined operation corresponding to the touched operation icon.

### CROSS REFERENCE TO RELATED APPLICATION

This application is based on Japanese Patent Application No. 2011-237156 filed on Oct. 28, 2011, the disclosure of which is incorporated herein by reference.

### TECHNICAL FIELD

The present disclosure relates to an in-vehicle display apparatus that displays operation icons on a display panel.

### BACKGROUND

An in-vehicle display apparatus, which is applied to a navigation apparatus, displays one or more icons on a display panel. The icons displayed on the display panel respectively correspond to predetermined operations. The predetermined operations may include setting a destination, registering information of a position, setting audio and the like. A touch panel switch is disposed on a surface of the display panel. When an icon displayed on the display panel is manipulated by a user by touching, a point on the touch panel switch corresponding to a coordinate of the manipulated icon is activated. Thus, a manipulation of the icon is detected by the touch panel switch.

As disclosed in JP-A-2010-085207, especially in FIG. 18 to FIG. 22 of JP-A-2010-085207, the display panel of the in-vehicle display apparatus is equipped to, for example, an installment panel of a vehicle, and the icons are equally displayed on the display panel.

As described above, the display panel of the in-vehicle display apparatus is equipped to the installment panel of the vehicle. Thus, in a case where a user is seated on a driver seat or on a assistant driver seat, when (i) the user intends to manipulate a predetermined icon, and (ii) the predetermined icon is arranged at a distance from the seat where the user is seated, the user needs to extend his or her arm to touch the predetermined icon. Further, when the user changes his or her mind during approach to the predetermined icon and intends to manipulate another icon, the user needs to move his or her hand in front of the display panel.

### SUMMARY

In view of the foregoing difficulties, it is an object of the present disclosure to provide an in-vehicle display apparatus, which displays icons so that the icons are selectively manipulated by a user from a position near to a seat where the user is seated.

According to an aspect of the present disclosure, an in-vehicle display apparatus includes, which controls a display panel equipped to a vehicle to display a plurality of operation icons to be manipulated by a user, includes a finger position detector, a display controller, and a touch panel switch. The finger position detector detects an approach of a finger and a finger approach position. The finger approach position is defined as a point on the display panel and corresponds to a fingertip of the finger. The display controller controls the display panel to display an icon display window on the display panel. The icon display window includes the operation icons. The touch panel switch is disposed on a surface of the display panel. The touch panel switch generates an input signal corresponding to one of the operation icons when detecting that the one of the operation icons is touched by the user. The touch panel switch further transmits the input signal to the display controller. The icon display window has two display modes including a rearrange target display mode in which the operation icons displayed in the icon display window are to be rearranged and an adjacence display mode in which the operation icons are displayed adjacent to the finger approach position in the icon display window. In a case where the icon display window is displayed in the rearrange target display mode and a display control start condition is satisfied, the display controller controls the display panel to display the icon display window in the adjacence display mode when the finger position detector detects the approach of the finger to the display panel. When the display controller receives the input signal from the touch panel switch, the display controller executes a predetermined operation corresponding to the one of the operation icons.

In the above apparatus, in a case where the icon display window is displayed in the rearrange target display mode and the display control start condition is satisfied, the display controller controls the display panel to display the icon display window in the adjacence display mode when the finger position detector detects the approach of the finger to the display panel. Thus, the operation icons are selectively manipulated by the user from a position near to a seat where the user is seated.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing an in-vehicle display apparatus, which is applied to an in-vehicle navigation apparatus, according to a first embodiment;

FIG. 2 is a front view of an installment panel equipped to a vehicle;

FIG. 3 is a front view of a display panel;

FIG. 4 is a flowchart showing a control process executed by a controller of the in-vehicle display apparatus according to the first embodiment;

FIG. 5 is a diagram showing an icon display window in which operation icons are displayed in a rearrange target display mode;

FIG. 6 is a diagram showing operation icons during a moving;

FIG. 7 is a diagram showing an icon display window after the moving of the operation icons according to the first embodiment;

FIG. 8 is a diagram showing an icon display window after a moving of operation icons according to a second embodiment;

FIG. 9 is a diagram showing an icon display window after a moving of operation icons according to a third embodiment;

FIG. 10 is a flowchart showing a control process executed by a controller of an in-vehicle display apparatus according to a fourth embodiment;

FIG. 11 is a flowchart showing a detailed process executed at step Sb in FIG. 10;

FIG. 12 is a diagram showing an icon display window after a moving of operation icons according to the fourth embodiment;

FIG. 13 is a diagram showing an icon display window after a moving of operation icons according to a fifth embodiment;

FIG. 14 is a block diagram showing an in-vehicle display apparatus, which is applied to an in-vehicle navigation apparatus, according to a sixth embodiment;

FIG. 15 is a flowchart showing a control process executed by a controller of the in-vehicle display apparatus according to the sixth embodiment; and

FIG. 16 is a diagram showing an icon display window after a moving of operation icons according to the sixth embodiment.

### DETAILED DESCRIPTION

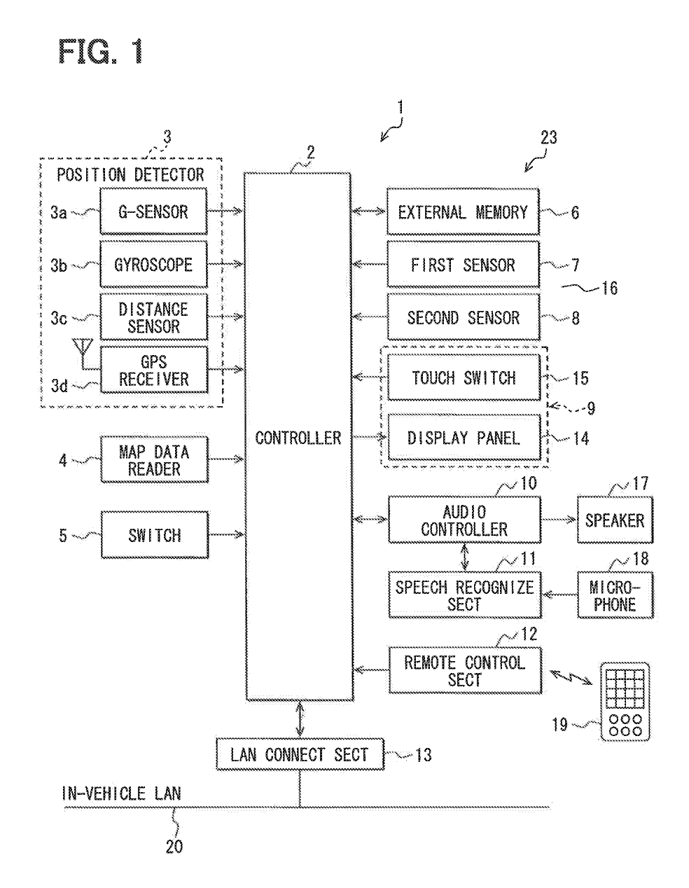

An in-vehicle display apparatus 23 according to a first embodiment of the present disclosure will be described with reference to FIG. 1 to FIG. 7. In the present disclosure, the in-vehicle display apparatus 23 is applied to a display apparatus of an in-vehicle navigation apparatus 1.

As shown in FIG. 1, the in-vehicle navigation apparatus 1 includes the in-vehicle display apparatus 23, a controller 2, a position detector 3, a map data reader 4, a switch group 5, an external memory 6, a display section 9, an audio controller 10, a speech recognize section 11, a remote control sensor 12, and an in-vehicle local area network (LAN) connection section 13. In the present embodiment, the controller 2 and the display section 9 are shared by the in-vehicle navigation apparatus 1 and the in-vehicle display apparatus 23. Alternatively, the in-vehicle navigation apparatus 1 and the in-vehicle display apparatus 23 may respectively have separate controllers. As shown in FIG. 1, the in-vehicle display apparatus 23 includes the controller 2, a finger position detector 16, and the display section 9. The display section 9 further includes a display panel 14 and a touch panel switch 15; the finger position detector 16 further includes a first sensor 7, a second sensor 8, and the controller 2. The first sensor 7 and the second sensor 8 provide a finger approach detector, and the controller 2 provides a finger behavior detector.

The controller 2 includes a central processing unit (CPU), a random access memory (RAM), a read only memory (ROM), and an input/output (I/O) bus. The controller 2 executes a control process in order to control the in-vehicle navigation apparatus 1. The position detector 3 includes an accelerator sensor (G-sensor) 3a, a gyroscope 3b, a distance sensor 3c, and a global positioning system (GPS) receiver 3d. Each of the G-sensor 3a, the gyroscope 3b, the distance sensor 3c, and the GPS receiver 3d has a different detection error from one another. The controller 2 detects and specifies a present position of a vehicle based on signals detected by the G-sensor 3a, the gyroscope 3b, the distance sensor 3c, and the GPS receiver 3d. The position detector 3 does not necessarily include all of the G-sensor 3a, the gyroscope 3b, the distance sensor 3c, and the GPS receiver 3d. That is, the position detector 3 may selectively include some of the G-sensor 3a, the gyroscope 3b, the distance sensor 3c, and the GPS receiver 3d. For example, the G-sensor 3a, the gyroscope 3b, the distance sensor 3c, and the GPS receiver 3d may be selectively included in the position detector 3 under a condition that the position detector 3 is able to detect the present position of the vehicle with a predetermined accuracy. Further, the position detector 3 may include a steering sensor, which detects a steering angle of a steering wheel, and a wheel sensor, which detects the rotation number of a wheel.

The map data reader 4 may be equipped with a storage media such as a CD-ROM, a DVD-ROM, a memory card, and a HDD. The map data reader 4 reads a map data and a map matching data stored in the storage media, and transmits the map data and the matching data to the controller 2. The switch group 5 includes one or more mechanical keys. Some of the mechanical keys are arranged around the display section 9, and some of the mechanical keys are equipped to a steering wheel. When detecting that a user performs an operation by manipulating the switch group 5, the switch group 5 transmits an operation detection signal to the controller 2. The operations performed by the user may include, for example, displaying a menu, setting a destination, searching for a route, starting a route guidance, switching from a present display window to another display window, performing an audio volume control.

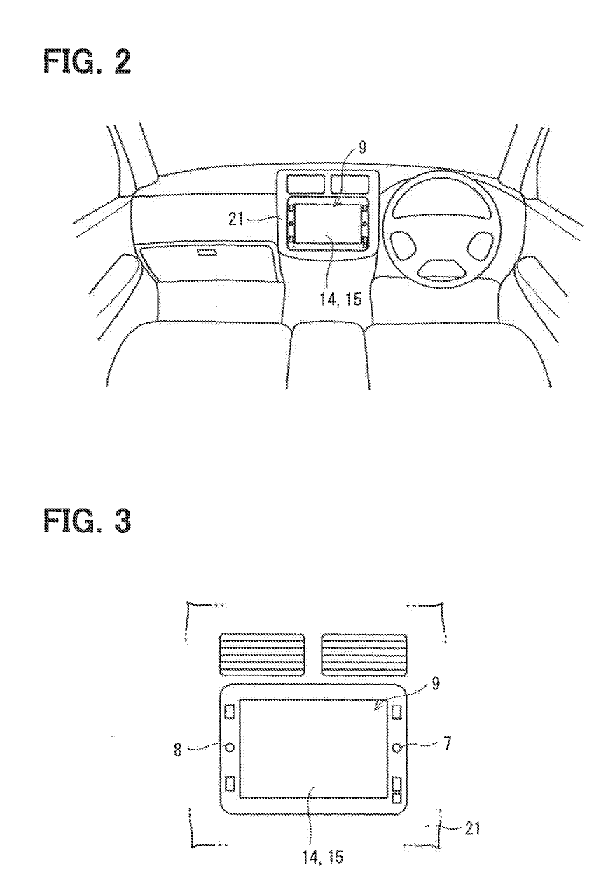

As shown in FIG. 2, the display section 9 is equipped to an installment panel 21. The display section 9 includes the display panel 14, which is provided by a colored liquid crystal display, and the touch panel switch 15, which is disposed on an entire region of a surface of the display panel 14. The surface of the display panel 14 on which the touch panel switch 15 is disposed is defined as a front surface of the display panel 14. The controller 2 controls the display panel 14 to display a predetermined display window. Thus, the display window displayed on the display panel 14 is switched to another display window based on a control process executed by the controller 2. The controller 2 controls the display panel 14 to display various display windows including, for example, a menu window, a destination setting window, and a route guidance window. Further, a mark indicating the present position of the vehicle and a traveling locus of the vehicle are displayed in an overlapped manner in a display window, which includes a map.

The display windows displayed on the display panel 14 further include an icon display window (IDW), which includes one or more icons for performing different operations. The icon display window may be displayed in an entire region of the display panel 14 or in a partial region of the display panel 14. Hereinafter, the icons for performing different operations are referred to as operation icons. The icon display window has two display modes including a rearrange target display mode (RTDM) and an adjacence display mode (ADM). The rearrange target display mode is defined as a display mode in which the operation icons need to be rearranged. Specifically, the rearrange target display mode is a static state of the operation icons, which need to be rearranged. In the rearrange target display mode, the operation icons may be equally arranged in the icon display window. Further, the operation icons may be arranged in another manner other than being equally arranged in the rearrange target display mode. The adjacence display mode is defined as a display mode in which the operation icons are displayed adjacent to a finger approach position, which will be described later. Specifically, the adjacence display mode includes a moving state, in which the operation icons are moving from initial display positions toward predetermined display positions, and a static state, in which the operation icons are arranged at the predetermined display positions. Thus, compared with the rearrange target display mode, the operation icons are more adjacent to the finger approach position in the adjacence display mode. In the present disclosure, a thumb is also referred to as a finger for convenience of description, and the finger approach position is defined as a point on the display panel 14 to which a user approaches with a finger. Specifically, the finger approach position corresponds to a fingertip of the finger of the user.

When the user manipulates an operation icon, the touch panel switch 15 generates an input signal corresponding to the manipulated operation icon, and transmits the input signal to the controller 2. The touch panel switch 15 is sensitive to touch, force, or pressure. Thus, the user may manipulate the touch panel switch 15 by touching, forcing, or pressing the touch panel switch 15 with a finger. As shown in FIG. 3, the first sensor 7 is arranged on a left side of the display section 9, and the second sensor 8 is arranged on a right side of the display section 9. Each of the first sensor 7 and the second sensor 8 is provided by a camera, and data of images shot by the first sensor 7 and the second sensor 8 are transmitted to the controller 2. The controller 2 includes the finger behavior detector, which detects an approach behavior of a finger to the display panel 14, and the finger approach position on the display panel 14. Hereinafter, the approach behavior of the finger to the display panel 14 is also referred to as a finger approach. As described above, the finger behavior detector, the first sensor 7, and the second sensor 8 configure the finger position detector 16.

The first sensor 7 and the second sensor 8 shoot images of a front region of the display panel 14. In an image shot by the first sensor 7 and the second sensor 8, a predetermined imaginary frame is set to define a determination region. Thus, the determination region is included in the front region of the display panel 14. The predetermined imaginary frame is defined by the controller 2 in such a manner that the determination region substantially corresponds to the display panel 14. That is, the front region is a broader than the determination region. The finger position detector 16 determines whether the finger approaches to the display panel 14 based on the image defined by the determination region.

Further, the finger behavior detector has one or more image data in order to detect a finger from the image, which is shot by the first sensor 7 and the second sensor 8. The image data include a finger image data and a hand image data. Specifically, the finger image data is a data of a finger image that shows one or more fingers, and the hand image data is a data of a hand image that shows a hand with one or more fingers pointed. The finger image and the hand image, whose data are used to detect a finger from the image shot by the first sensor 7 and the second sensor 8, includes at least a fingertip. Thus, the finger image data and the hand image data at least include a fingertip data. Hereinafter, the image data, which is used to detect a finger from the image shot by the first sensor 7 and the second sensor 8, is also referred to as finger detect image data. For example, a finger detect image data for detecting a finger shown in FIG. 6 includes a fingertip data corresponding to a fingertip Ys. A position of the fingertip Ys in the determination region corresponds to a finger approach position on the display panel 14. Hereinafter, the image, which is shot by the first and second sensors 7, 8, is referred to as an image shot for description convenience.

When the finger position detector 16 detects that the image shot of the determination region includes a finger and a data of the image shot is similar to one of the finger detect image data, the controller 2 determines that a finger approaches to the display panel 14. When the finger position detector 16 detects that the finger moves in the image shot of the determination region, the controller 2 determines that the finger moves in front of the display panel 14 within the determination region. When the finger position detector 16 detects that the finger stays still in the image shot of the predetermination region for a predetermined time, the controller 2 determines that the finger stops moving in front of the display panel 14. When the controller 2 detects that a size of the finger in the image shot becomes smaller than a predetermined image size, or the finger disappears from the image shot, the controller 2 determines that the finger moved away from the display panel 14.

The in-vehicle navigation apparatus 1 may further include a speaker 17, a microphone 18, and a remote controller 19. The audio controller 10 outputs an audio guidance, such as a warming alarm and an audio route guidance, from the speaker 17. The speech recognize section 11 is controlled by the controller 2. When the speech recognize section 11 is activated, the speech recognize section 11 recognizes an audio signal transmitted from the microphone 18 based on a speech recognition algorithm executed by the controller 2. When receiving an operation signal from the remote controller 19, the remote control sensor 12 transmits the operation signal to the controller 2, and the controller 2 performs an operation corresponding to the operation signal. The in-vehicle LAN connection section 13 provides an interface to an in-vehicle LAN 20. The in-vehicle LAN connection section 13 receives a speed signal, an accessory (ACC) signal, a parking brake signal via the in-vehicle LAN 20, and transmits the speed signal, the ACC signal, and the parking brake signal to the controller 2. The speed signal is generated based on a pulse signal, which is output from a speed sensor (not shown) equipped to the vehicle. The ACC signal indicates a state of an ACC switch, and includes an ON state and an OFF state. The parking brake signal indicates whether the vehicle is in a parked state or not. When the vehicle is parked, the parking brake signal is in an ON state; when the vehicle is non-parked, that is traveling, the parking brake signal is in an OFF state.

From a functional point of view, the controller 2 includes a map data acquire section, a map specify section, a route search section, a route guide section, and a drawing section. The map data acquire section acquires a data of a map indicating an area. The map specify section specifies a road including the present position of the vehicle based on the present position of the vehicle and road data included in the map data acquired by the map data acquire section. The route search section searches for a guidance route from the present position of the vehicle to a destination set by the user. The route guide section performs a route guidance by calculating one or more necessary positions to go through based on the guidance route, the road data included in the map data, and one or more position data of one or more intersections included in the map data. The drawing section generates a guidance map around the present position of the vehicle. The guidance map includes a simplified view of a highway, an amplified view of an intersection and the like.

As described above, the in-vehicle display apparatus 23 includes the controller 2, the display section 9 having the display panel 14 and the touch panel switch 15, and the finger position detector 16 having the first sensor 7, the second sensor 8, and the finger behavior detector.

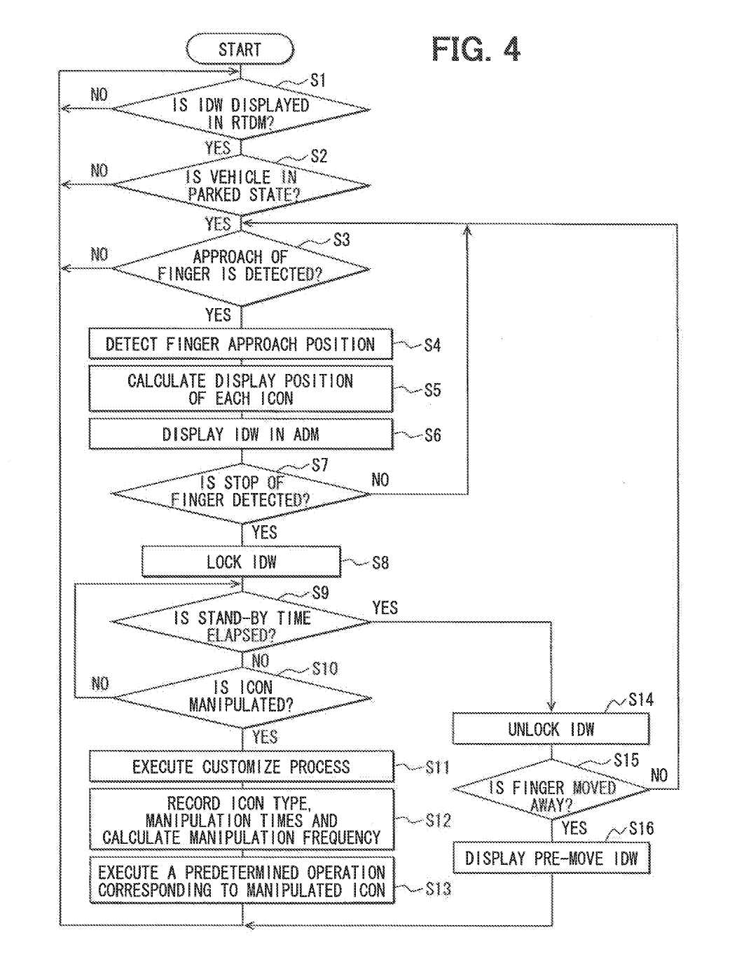

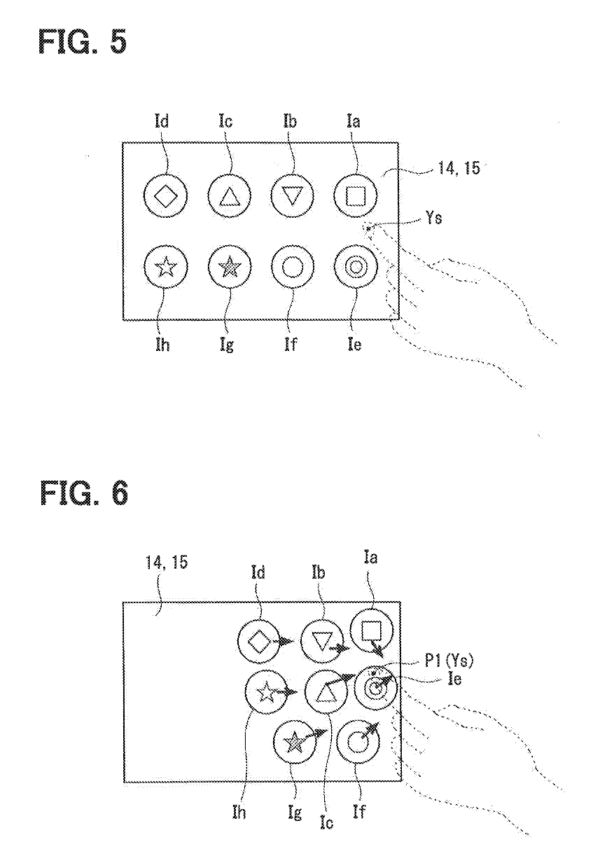

The controller 2 further provides a display controller and a learning section, which calculates a manipulation frequency. The following will describe a control process executed by the controller 2 in order to function as the display controller and the learning section with reference to FIG. 4. For example, when the ACC signal is input to the controller 2, the controller 2 may start to execute the process shown in FIG. 4. First, at step S1, the controller 2 determines whether the icon display window is displayed in the rearrange target display mode in which a part of or all of the operation icons need to be rearranged. For example, when a part of or all of the operation icons are equally arranged, the equally arranged operation icons need to be rearranged. That is, when the icon display window is displayed in the rearrange target display mode, the operation icons need to be rearranged corresponding to a moving of the finger on the display panel 14. An example of the rearrange target display mode is shown in FIG. 5. As shown in FIG. 5, the icon display window displayed in the rearrange target display mode may be a menu window in which all of the operation icons Ia, Ib, Ic, Id, Ie, If, Ig, Ih are equally arranged. The icon display window displayed in the rearrange target display mode may also be a menu window in which a part of the operation icons Ia, Ib, Ie, If, Ig are equally arranged, and the other part of the operations icons Ic, Id, Ih are arranged in another manner other than the equally arranged manner.

Each of the operation icons Ia to Ih schematically indicates a corresponding operation. A mark of the operation icon may be a character icon (not shown) other than a symbol icon, which is shown in FIG. 5 and FIG. 6. In the present embodiment, the operation icons Ia to Ih are symbol icons, and each of the operation icons Ia to Ih has a different shape from another. Further, each of the operation icons Ia to Ih corresponds to a different operation.

At step S1, when the controller 2 determines that the icon display window is displayed in the rearrange target display mode, the process proceeds to step S2. At step S2, the controller 2 determines whether the vehicle is in the parked state based on the parking brake signal. For example, the controller 2 may determine that the vehicle is in the parked state when the parking brake signal is in the On state. Further, for example, the controller 2 may determine that the vehicle is in the parked state when a vehicle speed calculated from the speed signal is zero.

When the controller 2 determines that the vehicle is in the parked state, the process proceeds to step S3. At step S3, the controller 2 determines whether a finger approaches to the display panel 14 based on a detection result of the finger position detector 16. When the controller 2 determines that the finger approaches to the display panel 14, the process proceeds to step S4. At step S4, as shown in FIG. 6, the finger position detector 16 detects and calculates a finger approach position P1 to which a fingertip Ys approaches. Specifically, the finger position detector 16 detects and calculates a coordinate of the finger approach position P1 on the display panel 14. Then, the process proceeds to step S5. At step S5, the display controller calculates display positions of the operation icons Ia to Ih on the display panel 14 based on the finger approach position P1. When the manipulation frequency is not calculated by the learning section, the display positions of the operation icons Ia to Ih are calculated in such a manner that the operation icons Ia to Ih are rearranged based on a distance between each of the operation icons Ia to Ih and the finger approach position P1. Specifically, an operation icon having a smaller distance than another operation icon is arranged nearer to the finger approach position P1. Further, when the manipulation frequency is calculated by the learning section, an operation icon having a higher manipulation frequency than another operation icon is arranged nearer to the finger approach point P1. Then, the process proceeds to step S6.

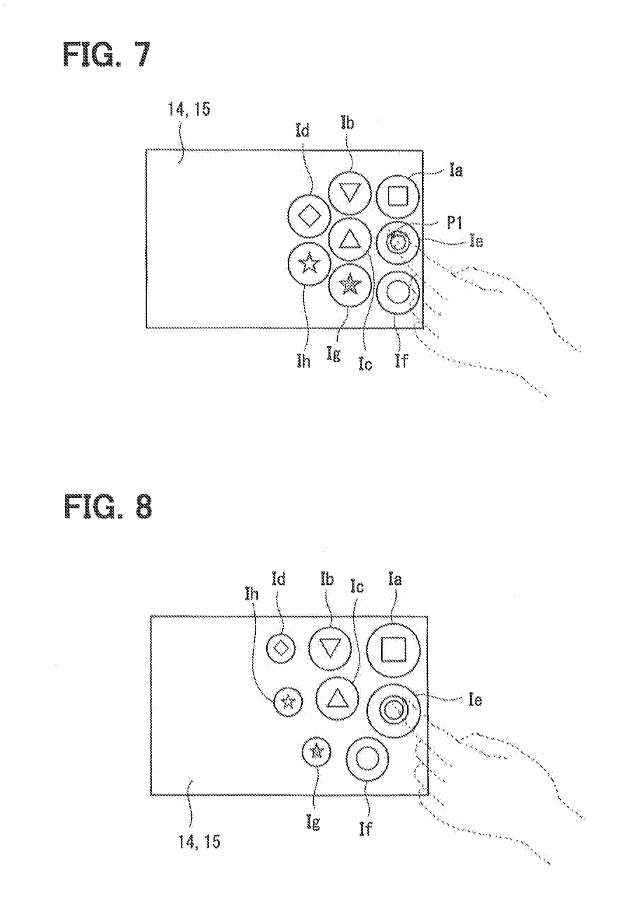

At step S6, the display controller controls the display panel 14 to display the icon display window in such a manner that the operation icons Ia to Ih are displayed at the corresponding display positions calculated at step S5. That is, the operation icons Ia to Ih are moved toward the finger approach position P1 so that the operation icons are displayed at the calculated display positions. FIG. 6 shows the moving state of the operation icons Ia to Ih, and FIG. 7 shows the static state of the operation icons Ia to Ih after the moving.

The display position of each of the operation icons Ia to Ih is calculated in such a manner that a display position of an operation icon is not overlapped with a display position of another operation icon. The following will describe an exemplary method of calculating the display positions of the operation icons Ia to Ih. A display position of a first operation icon, which is defined as an operation icon to be moved firstly, is calculated in such a manner that the display position of the first operation icon is overlapped with the finger approach position P1. Then, a display position of a second operation icon, which is defined as an operation icon to be moved secondly, is calculated based on the display position of the first operation icon and a size of the first operation icon. Display positions of the other operation icons are calculated in a similar way. Alternatively, the display positions of the operation icons Ia to Ih may be calculated in another method. For example, when the icon display window displayed on the display panel 14 is a cell-based icon display window, that is one cell corresponds to one operation icon, the cells in which the operation icons Ia to Ih are to be arranged may be determined by the finger approach position P1. The display positions of the operation icons Ia to Ih may be calculated in another method other than above-described methods.

During the moving of the operation icons Ia to Ih, the operation icons Ia to Ih may be displayed in the icon display window with original sizes and original color strengths. Further, during the moving of the operation icons Ia to Ih, the operation icons Ia to Ih may be displayed in a fade-out and fade-in manner. Specifically, the operation icons Ia to Ih gradually fade out at original display positions when the moving starts. After the moving is finished, the operation icons Ia to Ih gradually fade in to have the original sizes and the original color strengths at the calculated new display positions. Further, during the moving of the operation icons Ia to Ih, when one operation icon touches with another operation icon, the operation icons Ia to Ih may be displayed in such a manner that the one operation icon bumps the another operation icon. The operation icons Ia to Ih may also be displayed in a manner other than above-described manners during the moving. Then, the process proceeds to step S7.

At step S7, the controller 2 determines whether the finger stops moving based on the detection result of the finger position detector 16. That is, the controller 2 determines whether the finger approach position P1 is changed or not on the display panel 14. When the controller 2 determines that the finger continues moving without stop, the process proceeds to step S3, and the controller 2 determines again whether the finger approaches to the display panel 14 based on the detection result of the finger position detector 16. At step S7, when the controller 2 determines that the finger stops moving, the process proceeds to step S8. At step S8, the display controller locks the icon display window, which is displayed in the adjacence display mode. Specifically, when the finger stops moving at a first moment during the approach of the finger to the display panel 14 and the icon display window is displayed in the moving state of the adjacence display mode at the first moment, the icon display window is locked in the moving state, which is displayed at the first moment. Specifically, when the display controller locks the icon display window at the first moment, the operation icons stop moving at certain positions between the initial display positions and the predetermined display positions adjacent to the finger approach position. Further, when the finger stops moving at a second moment during the approach of the finger to the display panel 14 and the icon display window is displayed in the static state of the adjacence display mode at the second moment, the icon display window is displayed in the static state of the adjacence mode, which is displayed at the second moment. Specifically, the operation icons are displayed at the predetermined display positions adjacent to the finger approach position. Then, the process proceeds to step S9. At step S9, the controller 2 stands by for a predetermined time, which is defined as a stand-by time. During the stand-by time, the controller 2 detects whether the user manipulates one of the operation icons Ia to Ih.

When the predetermined stand-by time elapses, at step S14, the display controller unlocks the icon display window, which is displayed in the adjacence display mode. Thus, the predetermined stand-by time is also referred to as an unlock condition. Specifically, when the predetermined stand-by time elapses, the icon display window displayed in the adjacence display mode is unlocked. Then, the process proceeds to step S15. At step S15, the controller 2 detects whether the finger moved away from the front region of the display panel 14 based on the detection result of the finger position detector 16. At step S15, when the controller 2 determines that the finger moved away from the front region of the display panel 14, the process proceeds to step S16. At step S16, the display controller reset the operation icons Ia to Ih so that the operation icons Ia to Ih are displayed at the original display positions. That is, the display controller controls the display panel 14 to display a pre-moving icon display window (PRE-MOVE IDW), which is defined as the icon display window before the moving of the operation icons Ia to Ih. At step S15, when the controller 2 determines that the finger moved away from the front region of the display panel 14, the process returns to step S3. That is, a reset trigger of the icon display window includes a moving away of the finger from the front region of the display panel 14. Further, the reset trigger of the icon display window may further include a twice touch or a long touch on a predetermined portion of the display panel 14. The predetermined portion of the display panel 14 is a portion where the operation icons Ia to Ih are not arranged after the moving. The reset trigger is defined as a condition under which the operation icons Ia to Ih are reset so the operation icons Ia to Ih are displayed at the original display positions.

At step S10, when the one of the operation icons Ia to Ih is manipulated, the process proceeds to step S11. Hereinafter, the one of the operation icons manipulated by the user is referred to as the manipulated operation icon. At step S11, the controller 2 performs a customize process. The customize process is a process for setting a display position of the manipulated operation icon. For example, the customize process may lock the manipulated operation icon at the present position corresponding to the finger approach position P1, or may move the manipulated operation icon to a new display position different from the present display position. The following will describe an example of the customize process. In a case where the manipulated operation icon is pressed for a predetermined time at the present display position, the manipulated operation icon is locked at the present display position. Then, the present display position of the manipulated operation icon is recorded as a customized display position. In a case where the finger moves on the display panel 14 with pressing the manipulated operation icon, the manipulated operation icon moves according to a moving of the finger. After the manipulated operation icon is moved to a new display position on the display panel 14, the new display position is recorded as the customized display position. Further, in this case, the manipulated operation icon is also referred to as a customized operation icon after the customized display position is recorded. When displaying the customized operation icon on a next rearrange target display mode, the customized operation icon is displayed at the customized display position on the display panel 14. Further, when the manipulated operation icon is pressed for a short time less than the predetermined time, the customize process is not executed, and the process proceeds to step S12.

At step S12, the learning section records a type of the manipulated operation icon and manipulation times of the manipulated operation icon is recorded, and calculates a manipulation frequency of the manipulated operation icon. Specifically, the manipulation frequency is defined as a ratio of total manipulation times of the manipulated operation icon to total manipulation times of all of the operation icons Ia to Ih. Further, when an operation icon has a great total manipulation times, the learning section may determine that the operation icon has a high manipulation frequency, and when an operation icon has a small total manipulation times, the learning section may determine that the operation icon has a low manipulation frequency.

At step S13, the controller 2 displays a display window corresponding to the manipulated operation icon on the display panel 14, and the controller 2 executes a predetermined operation corresponding to the manipulated operation icon. In this case, the predetermined operation corresponding to the manipulated operation icon may be a switchover to a subordinate display window. For example, when the manipulated operation icon is an air conditioner icon, a display window for setting the air conditioner is displayed on the display panel 14.

When the manipulation frequency of the manipulated operation icon is calculated at least one time, at step S5, the controller 2 calculates the display position of the manipulated operation icon with respect to the finger approach position P1 based on the manipulation frequency. That is, an operation icon having a higher manipulation frequency is arranged nearer to the finger approach position P1. When two operation icons have the same manipulation frequency, the one, which has a smaller distance to the finger approach position P1, is arranged nearer to the finger approach position P1. Thus, at step S6, an operation icon having a highest manipulation frequency is arranged nearest to the finger approach position P1.

In the present embodiment, when the predetermined stand-by time elapses (step S9: “YES”), the operation icons Ia to Ih are unlocked at step S14. Then, at step S15, the controller 2 detects whether the finger moved away from the front region of the display panel 14. When detecting that the finger moved away from the front region of the display panel 14 (step S15: “YES”), the process proceeds to step S16 to reset the operation icons Ia to Ih at the original display positions. That is, the pre-moving icon display window is displayed on the display panel 14 at step S16. When detecting that the finger stops moving in the front region of the display panel 14 (step S15: “NO”), the process returns to step S3.

With this configuration, under conditions that (i) the icon display window is displayed in the rearrange target display mode, and (ii) the vehicle is in the parked state, when the user approaches to the display panel 14 with the finger, the finger position detector 16 detects the approach of the finger and the finger approach position P1 on the display panel 14. Then, the display controller controls the display panel 14 to display the icon display window in the adjacence display mode in which the operation icons Ia to Ih are arranged adjacent to the finger approach position P1. Here, a display control start condition is defined as the vehicle is in the parked state.

With above-described configuration, the operation icons Ia to Ih move adjacent to the finger approach position P1. Thus, the user can selectively manipulate one of the operation icons Ia to Ih from a position near to a seat. Further, since, the display control start condition is defined as the parked state of the vehicle, the display control is performed only during the vehicle is in the parked state. Thus, the user can concentrate on a manipulation of the operation icons Ia to Ih.

Further, in the present embodiment, the operation icons Ia to Ih are displayed adjacent to the finger approach position P1. The operation icon having the higher manipulation frequency is arranged nearer to the finger approach position P1. With this configuration, the operation icon having the highest manipulation frequency is arranged nearest to the finger approach position P1. Thus, the user can manipulate the operation icons Ia to Ih with less moving. Further, the learning section calculates manipulation frequencies of the operation icons Ia to Ih. Thus, a list of the operation icons Ia to Ih based on the manipulation frequency from high to low is calculated and set by the learning section.

Further, in the present embodiment, when the finger position detector 16 detects that the finger stops moving before manipulating an operation icon on the display panel 14, the controller 2 locks the icon display window, which is displayed in the adjacence display mode. Specifically, when the finger stops moving during the icon display window is displayed in the moving state of the adjacence display mode, the icon display window is locked in the moving state of the adjacence display mode. Further, when the finger stops moving during the icon display window is displayed in the static state of the adjacence display mode, the icon display window is locked in the static state of the adjacence display mode. The operation icons Ia to Ih are being locked until the unlock condition is satisfied. With this configuration, when the user stops moving the finger, the icon display window is locked in the adjacence display mode. Thus, the user can easily find an operation icon and manipulate the operation icon.

### Second Embodiment

A second embodiment of the present disclosure will be described with reference to FIG. 8. When displaying the icon display window in the adjacence display mode, the operation icon having the higher manipulation frequency may be displayed in a greater size than the operation icon having the lower manipulation frequency. With this configuration, the operation icon having the higher manipulation frequency is displayed in an emphasized manner. For example, the manipulation frequency may be set to have three levels including a high level, medium level, and a low level. Then, display sizes of the icons may be set to 100 pixels, 60 pixels, and 30 pixels respectively corresponding to the high level, the medium level, and the low level. In this case, when displaying the operation icon having the high manipulation frequency in the emphasized manner, a frame of the operation icon may be highlighted by a significant color such as red. Alternatively, when displaying the operation icon having the high manipulation frequency in the emphasized manner, an entire region of the operation icon may be displayed in a strengthened color. According to the second embodiment, the operation icon having the higher manipulation frequency has a higher visibility.

### Third Embodiment

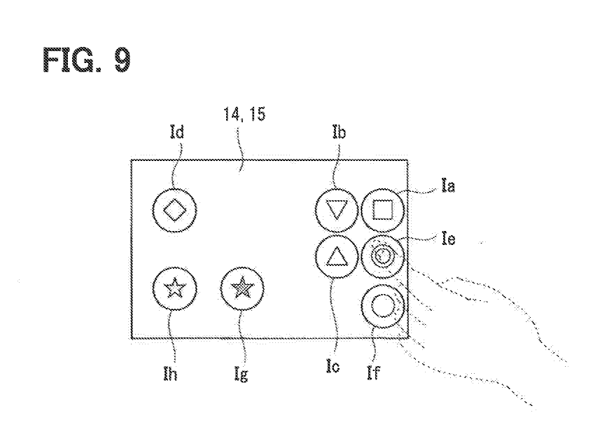

A third embodiment of the present disclosure will be described with reference to FIG. 9. As shown in FIG. 9, the manipulation frequency may be set to have two levels including a high level, and a low level. Then, an operation icon having the high level manipulation frequency is moved adjacent to the finger approach position P1, and an operation icon having the low level manipulation frequency is displayed at the original display position without moving.

### Fourth Embodiment

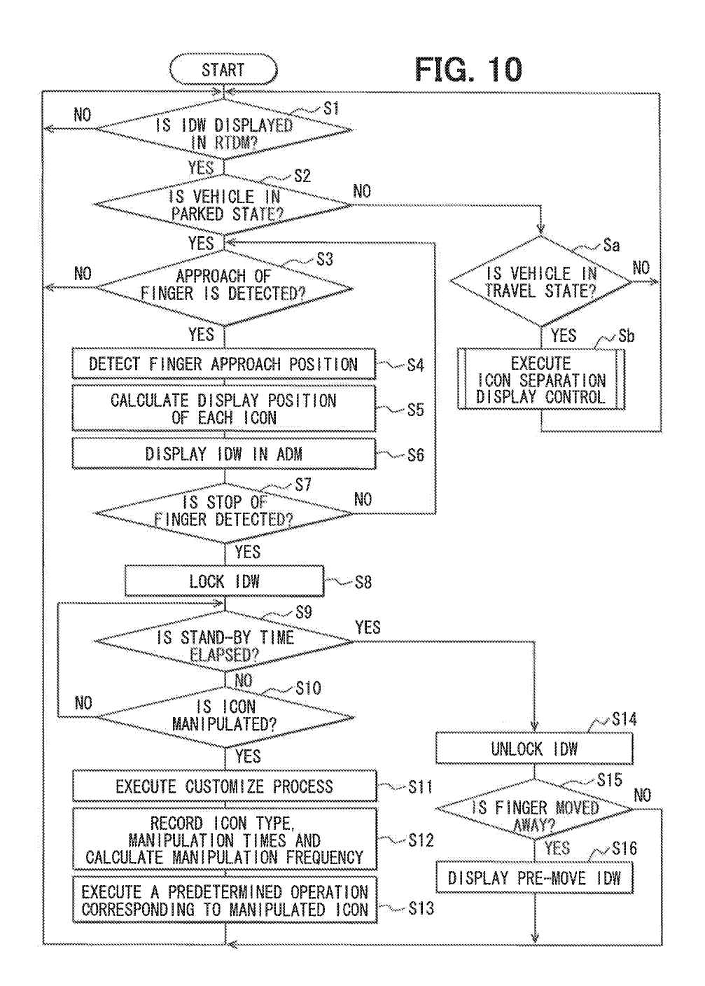

A fourth embodiment of the present disclosure will be described with reference to FIG. 10 to FIG. 12. Compared with the first embodiment, step Sa and step Sb is added to the control process executed by the controller 2 shown in FIG. 4. In the present embodiment, the display modes of the icon display window further includes a separation display mode (SDM). In the separation display mode, the operation icons Ia to Ih are displayed in the icon display window in such a manner that the operation icons Ia to Ih are displayed apart from the finger approach position P1. Specifically, the separation display mode includes a moving state, in which the operation icons are moving from the initial display positions toward predetermined display positions apart from the finger approach position P1, and a static state, in which the operation icons are displayed at the predetermined display positions apart from the finger approach position P1. A control process executed by the controller 2 according to the present embodiment is shown in FIG. 10. Specifically, at step S2, when determining that the vehicle is not in the parked state (step S2: “NO”), the process proceeds to step Sa. At step Sa, the controller 2 determines whether the vehicle is in a traveling state. When determining that the vehicle is in the traveling state (step Sa: “YES”), the controller 2 executes an icon separation display control.

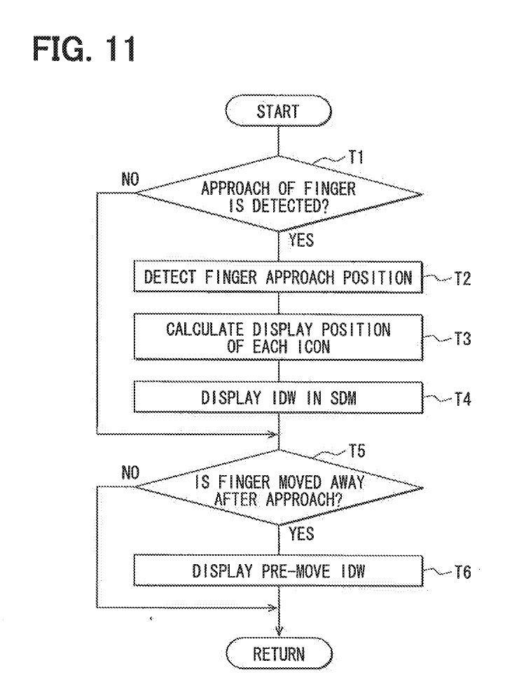

A process executed to perform the icon separation display control is shown in FIG. 11. The process for icon separation display control is performed as a subroutine process. At step T1, the controller 2 detects whether the user approaches to the display panel 14 with the finger based on the detection result of the finger position detector 16. When determining that the finger approaches to the display panel 14, at step T2, the finger position detector 16 calculates the coordinate of the finger approach position P1 on the display panel 14. At step T3, the controller 2 calculates the display positions of the operation icons Ia to Ih based on the finger approach position P1. The display positions of the operation icons are calculated in such a manner that the display positions are apart from the finger approach position P1.

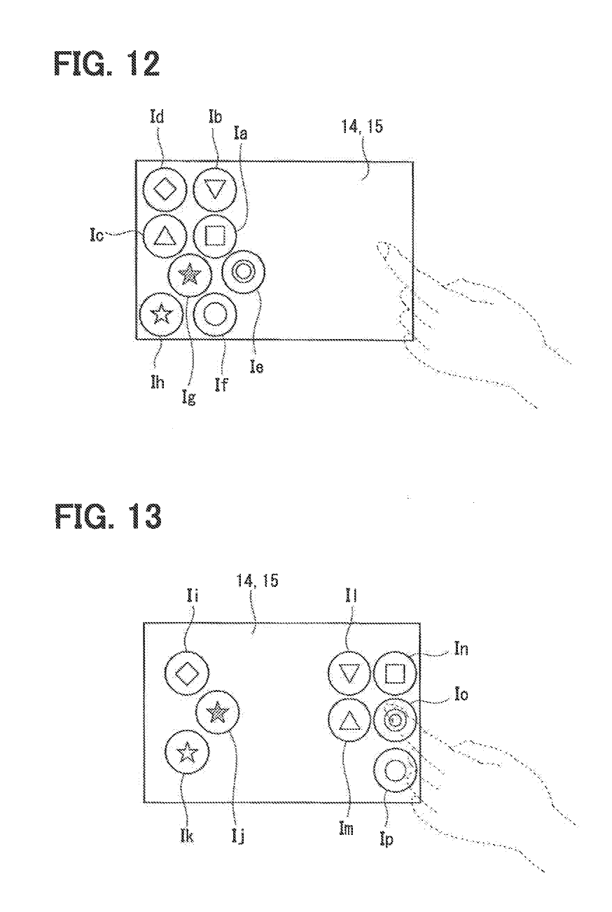

At step T4, the operation icons Ia to Ih are displayed at the corresponding display positions, which are apart from the finger approach position P1. That is, the icon display window is displayed in the separation display mode. An example of the separation display mode is shown in FIG. 12. In this case, the display positions of the operation icons Ia to Ih are calculated so that the display positions are not overlapped with one another. At step T5, the controller 2 determines whether the finger moved away from the front region of the display panel 14. When determining that the finger did not move away from the front region of the display panel 14, the process returns to step S1 of the control process shown in FIG. 10. In this case, when the finger stays still in the front region of the display panel 14 or further approaches to the display panel 14, the controller 2 determines that the finger did not move away from the display panel 14.

At step T5, when determining that the finger moved away from the display panel 14, the process proceeds to step T6. At step T6, the controller 2 resets the operation icons Ia to Ih so that the operation icons Ia to Ih are displayed at the original display positions before the moving. According to the fourth embodiment, when the finger position detector 16 detects that the finger approaches to the display panel 14, the controller 2 displays the icon display window in the separation display mode so that the operation icons Ia to Ih are displayed apart from the finger approach position P1. Thus, the operation icons Ia to Ih are hard to be manipulated during the traveling of the vehicle.

### Fifth Embodiment

A fifth embodiment of the present disclosure will be described with reference to FIG. 13. In the fifth embodiment, the display mode of the icon display window further includes a separation-adjacence display mode in which the operation icons Ii to Ip are displayed in such a manner that a part of the operation icons Ii to Ip are arranged adjacent to the finger approach position P1 and the other part of the operation icons Ii to Ip are arranged apart from the finger approach position P1. The separation-adjacence display mode is a combination of the separation display mode and the adjacence display mode. Specifically, the separation-adjacence display mode includes a moving state, in which the part of the operation icons Ii to Ip are moving toward the finger approach position P1 and the other part of the operation icons Ii to Ip are moving to the predetermined display positions apart from the finger approach position P1, and a static state, in which the part of the operation icons Ii to Ip are arranged adjacent to the finger approach position P1 and the other part of the operation icons Ii to Ip are arranged at the predetermined display positions apart from the finger approach position P1. For example, as shown in FIG. 13, the operation icons Ii to Ip are divided into two groups including a first group and a second group. The first group includes limited operation icons. The limited operation icon corresponds to an operation, which is limited to be manipulated during a vehicle traveling. Thus, it is preferable not to manipulate the limited operation icons during the vehicle traveling. In the present embodiment, the operation icons Ii to Ik are defined as the limited operation icons. The second group includes unlimited operation icons. The unlimited operation icon corresponds to an operation, which is unlimited to be manipulated during the vehicle traveling. Thus, manipulation of the unlimited operation icon during the traveling state is permissible. In the present embodiment, the operation icons Il to Ip are defined as the unlimited operation icons. According to the present embodiment, in a case where the display control start condition is not satisfied, that is, the vehicle is in the traveling state, when the finger position detector 16 detects that the finger approaches to the display panel 14, the icon display window is displayed in the separation-adjacence display mode. Specifically, in the separation-adjacence display mode, the limited operation icons Ii to Ik are displayed apart from the finger approach position P1, and the unlimited operation icons Il to Ip are displayed adjacent to the finger approach position P1.

According to the fifth embodiment, when displaying the limited operation icons and the unlimited operation icons, the limited operation icons are displayed apart from the finger approach position P1 so that the limited operation icons are hard to be manipulated, and the unlimited operation icons are displayed adjacent to the finger approach position P1 so that the unlimited operation icons are easy to be manipulated.

### Sixth Embodiment

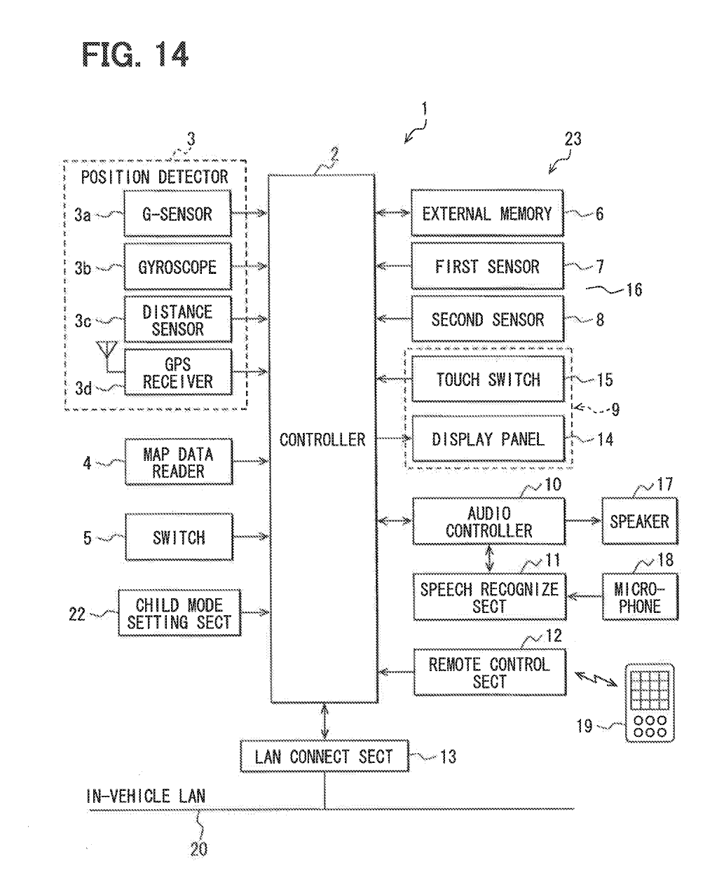

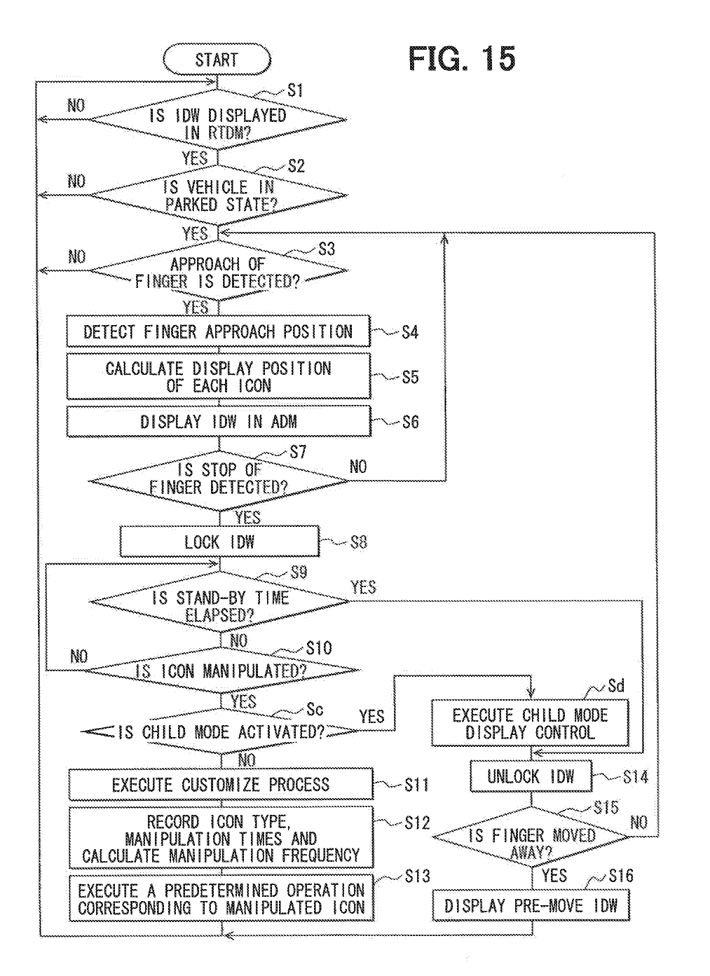

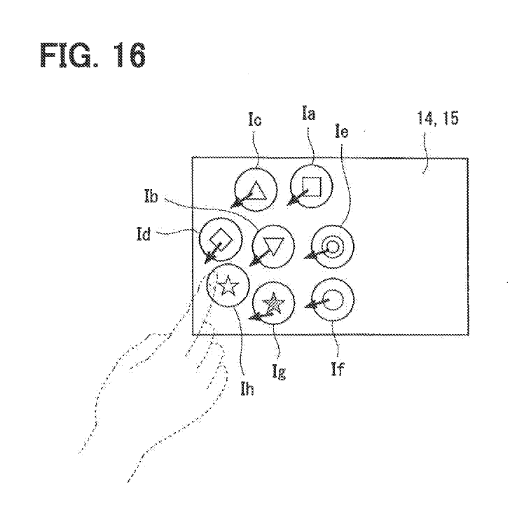

A sixth embodiment of the present disclosure will be described with reference to FIG. 14 to FIG. 16. In the present embodiment, the display modes of the icon display window further include a child display mode. Accordingly, the in-vehicle display apparatus 23 further includes a child mode setting section 22. The child mode setting section 22 may be provided by a child mode set switch. Specifically, the child mode set switch activates or deactivates a child mode. For example, the child mode switch may be equipped to the installment panel 21. Further, compared with the first embodiment, step Sc and step Sd are added to the control process executed by the controller 2 shown in FIG. 4. A control process executed by the controller 2 according to the present embodiment is shown in FIG. 15. The following will mainly describe differences of the present embodiment from the first embodiment. As shown in FIG. 15, step Sc is executed when the determination at step S10 is “YES”, and step Sd is executed when the determination at step Sc is “YES”.

As shown in FIG. 15, when the control process starts, step S1 to step S10 are executed in a similar way to the first embodiment. When the control process starts, the controller 2 determines whether the icon display window is displayed in the rearrange target display mode at step S1. When the icon display window is displayed in the rearrange target display mode, the controller 2 further determines whether the parking brake signal is in the On state at step S2. When the controller 2 determines that the parking brake signal is in the On state, the finger position detector 16 detects whether the finger approaches to the display panel 14 at step S3. When detecting that the finger approaches to the display panel 14, the finger position detector 16 calculates the coordinate of the finger approach position P1 at step S4. At step S5, the controller 2 calculates the display position of each of the operation icons Ia to Ih, which are to be displayed in the icon display window, based on the finger approach position P1. Then, the operation icons Ia to Ih are displayed at the calculated display positions in the icon display window at step S6. That is, the operation icons Ia to Ih are moved and arranged adjacent to the finger approach position P1.

When the finger position detector 16 detects that the finger stops moving at step S7, the controller 2 locks the icon display window displayed in the adjacence display mode at step S8. Then, at step S10, the controller 2 determines whether one of the operation icons Ia to Ih is manipulated by touching.

At step S10, when the controller 2 determines that one of the operation icons Ia to Ih is manipulated, the process proceeds to step Sc. At step Sc, the controller 2 determines whether the child mode is activated. When determining that the child mode is activated, the process proceeds to step Sd without execution of step S11, step S12, and step S13. At step Sd, the controller 2 switches the display mode of the icon display window from the adjacence display mode to the child display mode. That is, the controller 2 executes a child mode display control. Then, step S14 is executed. In the child display mode, when one of the operation icons Ia to Ih is manipulated, a color of the manipulated operation icon is changed. Further, the manipulated operation icon may be displayed in a blinking manner, or a size of the manipulated operation icon is increased. The manipulated operation icon may be displayed in a manner other than above-described manners.

When determining that the child mode is deactivated at step Sc, the process proceeds to step S11 similar to the first embodiment.

According to the sixth embodiment, the in-vehicle display control apparatus 23 includes the child mode setting section 22, which activates and deactivates the child mode. In a case where the child mode is activated, when the finger position detector 16 detects the approach of the finger, the controller2 controls the display panel 14 to display the icon display window in the adjacence display mode by execution of step S1 to step S10. Further, when the controller 2 receives the input signal from the touch panel switch 15, the controller 2 displays the icon display window in the child display mode at step Sd without execution of step S11 to step S13.

With this configuration, when a child approaches to the display panel 14 with a finger and moves the finger in the front region of the display panel 14, the operation icons Ia to Ih are being moved according to the moving of the finger. Thus, the child can play with the display panel 14. Further, even when the operation icon is manipulated by touching the touch panel switch 15, the operation corresponding to the operation icon is not performed. Instead, the operation icon is displayed in the child display mode. That is, when one of the operation icons Ia to Ih is manipulated, the icon display window for the child is displayed. Thus, the child can play with the display panel 14 without performing an actual operation corresponding to the manipulated operation icon.

In the present embodiment, the child mode switch, which provides the child mode setting section 22, is equipped to the installment panel 21 in order to activate and deactivate the child mode. Alternatively, a predetermined switch equipped to the switch group 5 or the remote controller 19 may provide the child mode setting section 22. In this case, the predetermined switch activates and deactivates the child mode by performing a predetermined manipulation such as long-press. Further, predetermined plural switches equipped to the switch group 5 or the remote controller 19 may provide the child mode setting section 22. In this case, the plural switches activate and deactivate the child mode by performing a predetermined manipulation such as pressing the plural switches at one time. Further, when displaying the icon display window in the adjacence display mode, one or more imaginary concentric circles may be defined around the finger approach position P1. As described above, the manipulation frequency may be set to have three levels including the high level, the medium level, and the low level. In this case, the operation icon included in the high level may be arranged in the firstly close concentric circle to the finger approach position P1. Further, the operation icon included in the medium level may be arranged in the secondly close concentric circle to the finger approach position P1. Further, the operation icon included in the low level may be arranged in the thirdly close concentric circle to the finger approach position P1. In the present disclosure, the manipulation frequency is set to have three levels. Alternatively, the manipulation frequency may be set to have two, four or more than four levels.

Further, the first sensor 7 and the second sensor 8 may be respectively arranged on an upside and a downside of the display panel 14. Further, the operation icons Ia to Ih may be displayed in a predetermined manner, which is set by the user, in the rearrange target display mode other than the equally arranged manner.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. An in-vehicle display apparatus, which controls a display panel equipped to a vehicle to display a plurality of operation icons to be manipulated by a user, comprising:
a finger position detector that detects an approach of a finger and a finger approach position, the finger approach position being defined as a point on the display panel and corresponding to a fingertip of the finger;
a display controller that controls the display panel to display an icon display window on the display panel, the icon display window including the operation icons; and
a touch panel switch disposed on a surface of the display panel, the touch panel switch generating an input signal corresponding to one of the operation icons when detecting that the one of the operation icons is touched by the user, the touch panel switch further transmitting the input signal to the display controller,
wherein the icon display window has two display modes including a rearrange target display mode in which the operation icons displayed in the icon display window are to be rearranged and an adjacence display mode in which the operation icons are displayed adjacent to the finger approach position in the icon display window,
wherein, in a case where the icon display window is displayed in the rearrange target display mode and a display control start condition is satisfied, the display controller controls the display panel to display the icon display window in the adjacence display mode when the finger position detector detects the approach of the finger to the display panel, and
wherein, when the display controller receives the input signal from the touch panel switch, the display controller executes a predetermined operation corresponding to the one of the operation icons.

2. The in-vehicle display apparatus according to claim 1,
wherein the rearrange target display mode is a static state in which the operation icons are arranged at initial display positions,
wherein the adjacence display mode includes a moving state, in which the operation icons are moving from the initial display positions toward predetermined display positions adjacent to the finger approach position, and a static state, in which the operation icons are arranged at the predetermined display positions adjacent to the finger approach position.

3. The in-vehicle display apparatus according to claim 1,
wherein the display control start condition is defined as whether the vehicle is in a parked state, and
wherein the display control start condition is satisfied when the vehicle is in the parked state.

4. The in-vehicle display apparatus according to claim 1, further comprising:
a learning section that calculates a manipulation frequency of each of the operation icons.

5. The in-vehicle display apparatus according to claim 4,
wherein the manipulation frequency is defined as a ratio of the number of total manipulation times of the each of the operation icons to the number of total manipulation times of all of the operation icons.

6. The in-vehicle display apparatus according to claim 4,
wherein the operation icons include a first operation icon and a second operation icon, and
wherein, when the first operation icon has a manipulation frequency higher than a manipulation frequency of the second operation icon, the display controller controls the display panel to display the icon display window in such a manner that the first operation icon is arranged nearer to the finger approach position compared with the second operation icon.

7. The in-vehicle display apparatus according to claim 6,
wherein when the first operation icon has a manipulation frequency higher than a manipulation frequency of the second operation icon, the display controller controls the display panel to display the icon display window in such a manner that the first operation icon is displayed in an emphasized manner compared with the second operation icon.

8. The in-vehicle display apparatus according to claim 2,
wherein the finger position detector further detects whether the finger stops moving during the approach of the finger to the display panel, and
wherein, when the finger position detector detects that the finger stops moving at a first moment during the approach of the finger to the display panel and the icon display window is displayed in the moving state of the adjacence display mode at the first moment, the display controller locks the icon display window so that the operation icons stop moving at certain positions between the initial display positions and the predetermined display positions adjacent to the finger approach position, until a predetermined unlock condition is satisfied.

9. The in-vehicle display apparatus according to claim 8,
wherein, when the finger position detector detects that the finger stops moving at a second moment during the approach of the finger to the display panel and the icon display window is displayed in the static state of the adjacence display mode at the second moment, the display controller controls the display panel to display the icon display window in the static state of the adjacence mode so that the operation icons are displayed adjacent to the finger approach position, until the predetermined unlock condition is satisfied.

10. The in-vehicle display apparatus according to claim 1,
wherein the icon display window has another display mode, which is a separation display mode,
wherein the operation icons are displayed apart from the finger approach position in the separation display mode, and
wherein, in a case where the display control start condition is not satisfied and the vehicle is in a traveling state, the display controller controls the display panel to display the icon display window in the separation display mode when the finger position detector detects the approach of the finger to the display panel.

11. The in-vehicle display apparatus according to claim 1,
wherein the operation icons include limited operation icons, which are limited to be manipulated during a traveling, and unlimited operation icons, which are unlimited to be manipulated during the traveling, and
wherein in a case where the control start condition is not satisfied and the vehicle is in a traveling state, the display controller controls the display panel to display the icon display window in such a manner that the limited operation icons are displayed apart from the finger approach position and the unlimited operation icons are displayed adjacent to the finger approach position when the finger position detector detects the approach of the finger to the display panel.

12. The in-vehicle display apparatus according to claim 1, further comprising:
a child mode setting section that activates and deactivates a child mode,
wherein, during the child mode is activated, when the finger position detector detects the approach of the finger to the display panel, the display controller controls the display panel to display the icon display window in the adjacence display mode, and
wherein, during the child mode is activated, when the touch panel switch generates the input signal corresponding to the one of the operation icons touched by the user, the display controller executes another predetermined operation for the child mode without executing the predetermined operation, which corresponds to the one of the operation icons.
